(19) United States
(12) Patent Application Publication
(10) Pub. No.: US 2003/0074434 A1
(43) Pub. Date: Apr. 17, 2003

(54) Determination of message source in network communications

(76) Inventors: James L. Jason JR., Hillsboro, OR (US); Chun Yang Chiu, Hillsboro, OR (US); Priya Govindarajan, Margeaux (PL); David M. Durham, Hillsboro, OR (US)

Correspondence Address: FISH & RICHARDSON, PC, 4350 LA JOLLA VILLAGE DRIVE, SUITE 500, SAN DIEGO, CA, 92122, US

(21) Appl. No.: 09/976,471

(22) Filed: Oct. 11, 2001

(51) Int. Cl. G06F 15/173; G06F 15/16

(52) U.S. Cl. 709/223; 709/229

(57) ABSTRACT

A system and method for determining the source, on a network, of unwanted messages generated by a malicious agent, toward a target device such as a web server. The malicious agent directs one or more computers on a sub network to direct a flood of communications toward the server on a second sub network designed to substantially reduce the ability of the server to respond to other communications. Messages passing through points on a path between the malicious agent computers and the server are monitored for indicia of messages uncharacteristic of normal network communication. The first point along the path that the unwanted messages pass through is identified. A network device at that point is instructed to block portion of communications passing through that point.

### TECHNICAL FIELD

This invention relates to the determination of message source in network communications.

### BACKGROUND

Two computers may communicate across a computer network by establishing a network connection, e.g., by performing a connection establishment protocol such as a three-way handshake. With reference to FIG. 1, a sending computer sends a synchronize (SYN) request across a network to a receiving computer informing that computer that the sending computer wishes to communicate (step 100). The receiving computer creates a resource (e.g., by allocating memory) to maintain connection information (step 102). The receiving computer then acknowledges (SYN-ACK) the SYN request by sending a communication across the network to the sending computer (step 104). The sending computer sends a final acknowledgement (ACK) message across the network to the receiving computer (step 106). The sending and receiving computers then exchange data (step 108). After the exchange of data is complete, the connection is closed (step 110). The receiving computer then frees the resource, making it available for other communications (step 112).

With reference to FIG. 2, the handshake mechanism for establishing a network can also be used by a malicious agent to overwhelm the processing capability of a receiving computer, such as a web server. For this purpose, the malicious agent may cause one or more sending computers to send a large number of SYN requests (step 200). For each one of the requests, the receiving computer creates a resource (step 202) as it sends the SYN-ACK (step 204). The malicious agent causes the sending computer(s) to fail to send an ACK message for each SYN-ACK message received from the receiving computer (step 206). The resources are not freed until a predetermined amount of time has expired without receiving a final ACK message. When the available amount of resources of the receiving computer that can be used for connection maintenance purposes is reached, the receiving computer cannot engage in legitimate handshaking to set up communications with other computers (step 208). This is called a SYN flood attack, a type of denial of service (DoS) attack.

A flood attack can be thwarted if the IP address of the attacking computer is known, because then all communications originating from that attacking computer can be blocked. However, a flood attacker can mask its identity by forging its source IP.

### DESCRIPTION OF DRAWINGS

FIG. 1 is a flow chart of a method of establishing network communication;

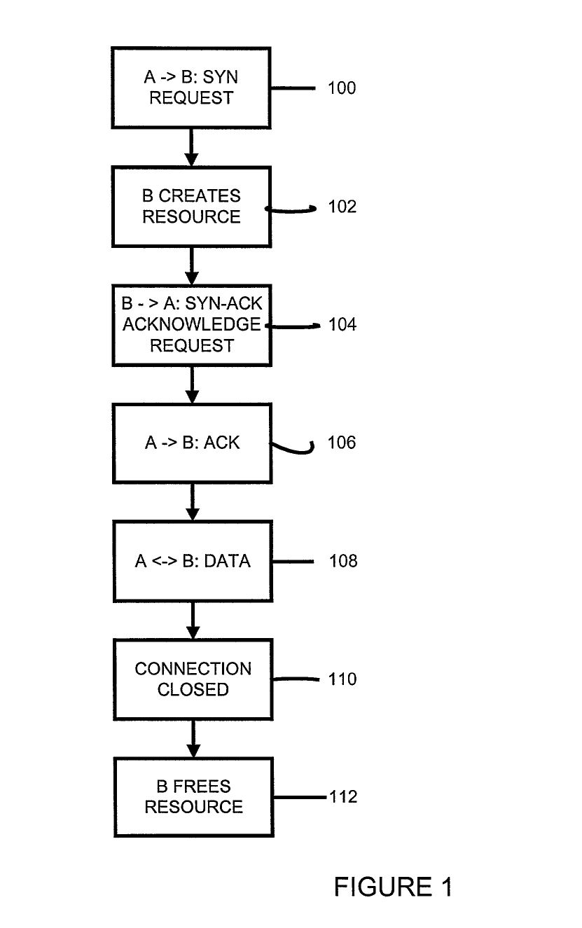

FIG. 2 is a flow chart of a synchronization request flood attack;

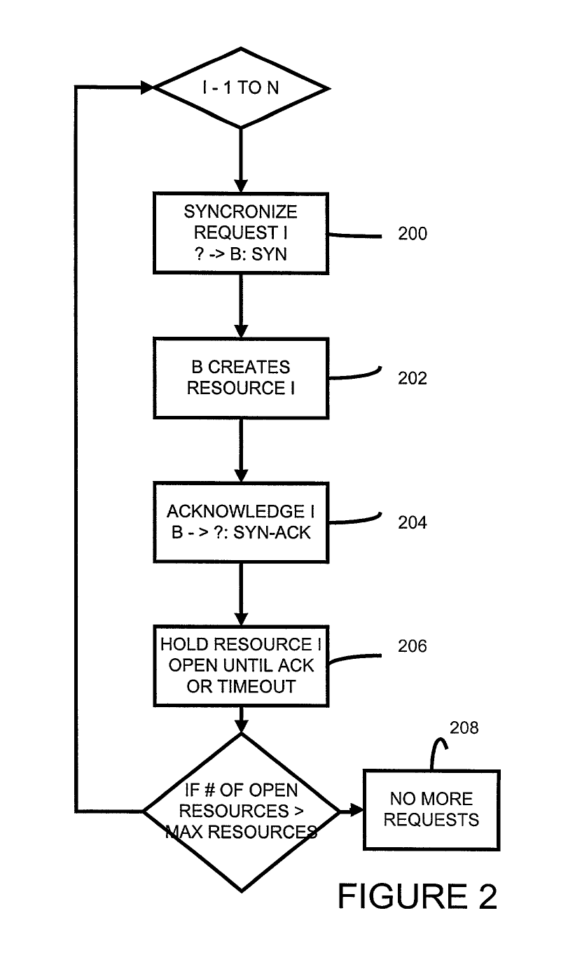

FIG. 3 is a flow chart of a method of determining a source of a flood attack;

FIG. 4 is a block diagram of a computer network;

FIG. 5 is a flow chart of a method of determining a source of a flood attack; and

FIG. 6 is a block diagram of an interface device.

### DETAILED DESCRIPTION

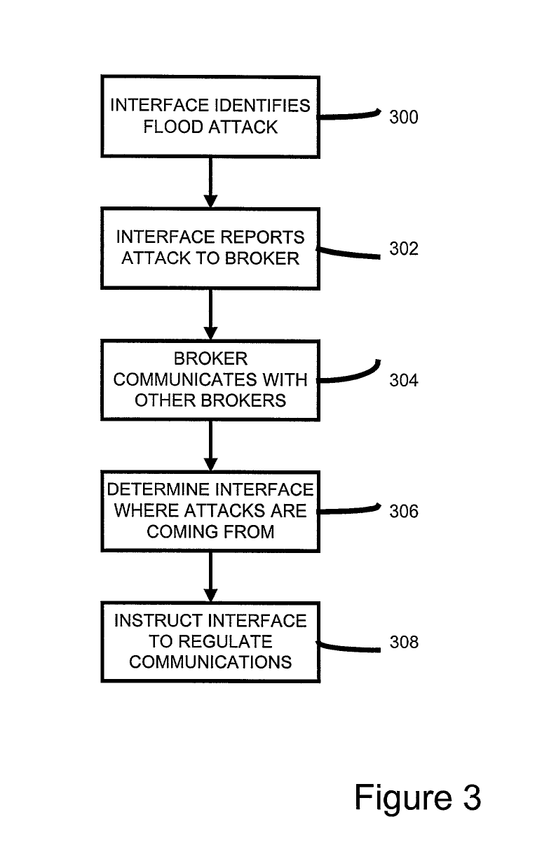

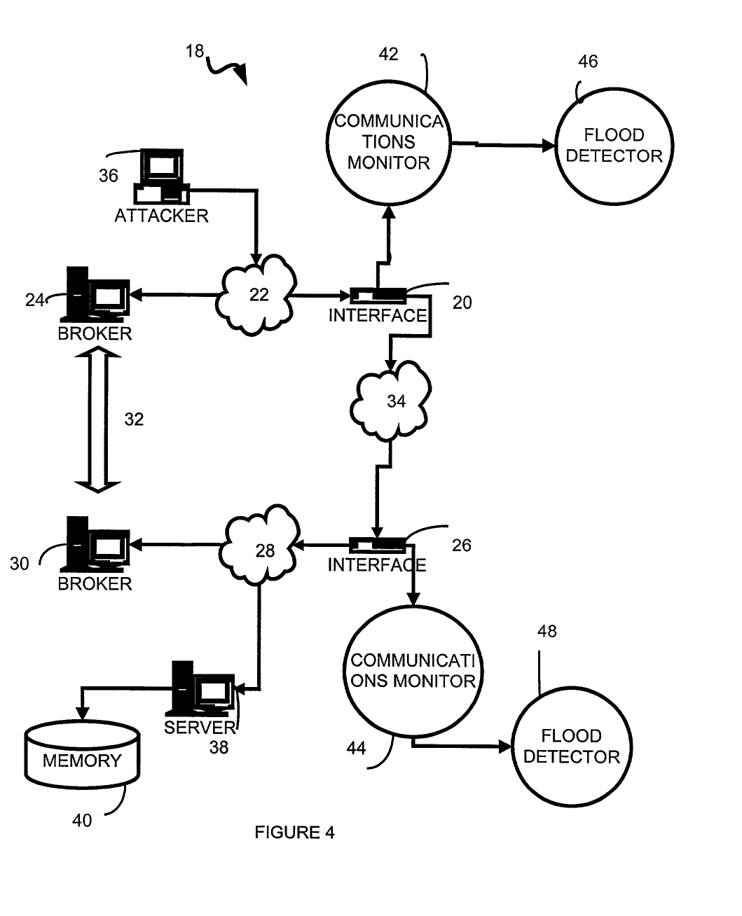

FIG. 3 shows a method of locating the source of a flood attack in a network 18 depicted in FIG. 4 by identifying a point through which all flood attack communications pass. A sending network interface device 20 monitors communications through it to identify indicia of a flood attack (step 300). The interface device reports the indicia of the attack to a sending broker 24 corresponding to the interface device 20 (step 302). The broker 24 communicates with other brokers, each with information collected from one or more corresponding interface devices (step 304). The brokers then identify the interface device through which the attack is originating (step 306). Communications through that interface device can then be regulated or suppressed to limit the extent of the flood attack and limit the harm caused to the target of the attack (step 308) while minimizing the blocking of legitimate network communications.

In the network 18, as is typically the case, the sending interface device 20 is connected across a sub network 22 to the sending broker 24, and a receiving interface device 26 communicates across a sub network 28 to a receiving broker 30. Alternately, a single broker is connected to both the sending and receiving interface devices. The brokers control and configure the interface devices and communicate to each other network-wide information, such as network topology (location of network components relative to other network components). There is a communication link 32 between the brokers. The two interface devices 20, 26 are connected to one another across a sub network 34. A sending computer, or attacker 36, on the sub network 22 communicates with a receiving computer, often a web server 38, on the sub network 28 by sending messages through the sending interface device 20. The messages are received at the server 38 through the receiving interface device 26. A computer memory 40 is connected to the server 38. When the server 38 receives a SYN request, it allocates a resource in the memory 40.

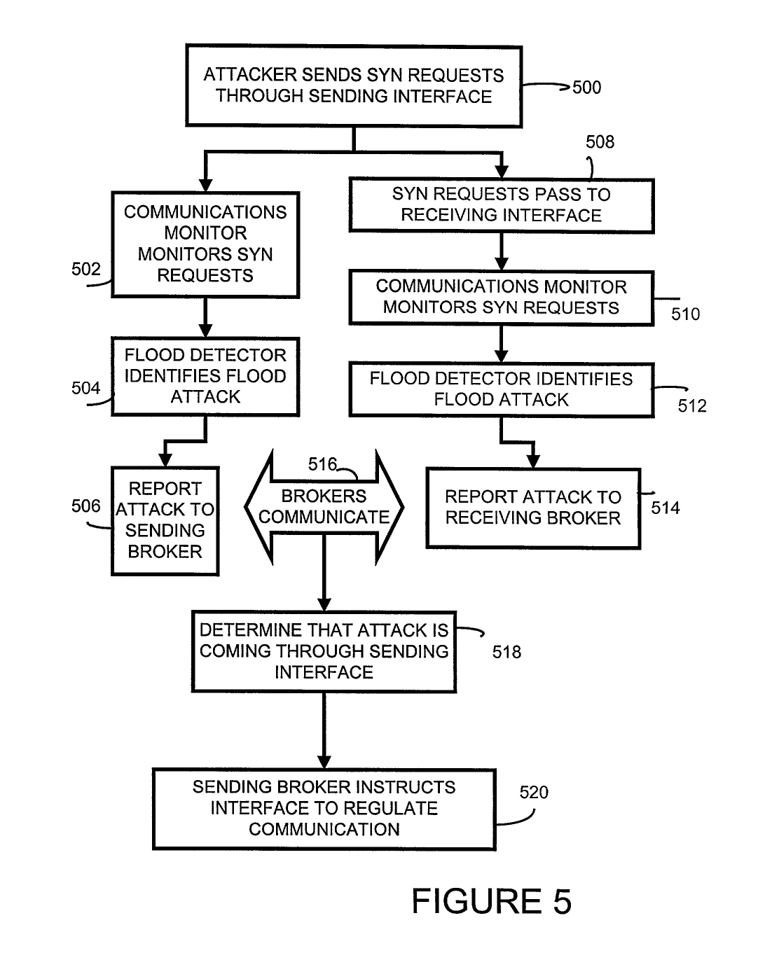

For the purpose of protecting the server 38 against a flood attack, each interface device 20, 26 includes a communications monitor 42, 44 with a flood detector 46, 48 for monitoring the messages passing through the interface device and identifying indicia of a flood attack. With reference also to FIG. 5, there is shown a method of identifying and blocking a SYN flood attack. As described above, the attacker 36 sends a flood of SYN requests through the sending interface device 20 (step 500). The sending communications monitor 42 monitors the messages, including the SYN requests, passing through the interface device 20 (step 502). The sending flood detector 46 detects that a flood is occurring through that interface device 20 (step 504). Specific methods of detecting a flood are described below. The sending communications monitor 42 may then analyze the IP header prepended to each message to determine information such as the direction and targets of the messages. The sending communications monitor 42 then informs the sending broker 24 of the existence of a flood attack and passes along the other information, such as the direction of the flood messages and any flood targets (such as the server 38) (step 506).

The attacker's SYN requests, after leaving the sending interface device 20, pass through the receiving interface device 26 to the server 38 (step 508). The receiving communications monitor 44 also monitors the messages passing through the receiving interface device 26 (step 510). The receiving flood detector 48 detects that a flood is occurring through the receiving interface device 26 (step 512). The receiving communications monitor 44 informs the receiving broker 30 of the existence of a flood attack and passes along other information, such as the direction of the flood messages and any flood targets (such as the server 38) (step 514). Similarly, other interface devices along the path between the attacker and the server may also detect the existence of the flood attack and inform their corresponding brokers.

The brokers detecting the attack then exchange information, including the presence of the attack and any directional information or flood attack targets (step 516). As described above, the brokers have network topology information. Using the flood attack information from a plurality of interface devices along with the network topology information, the brokers identify the sending interface device 20 as the interface device that the SYN flood messages initially pass through (step 518). Thus, by collaborating, the brokers are able to determine that the attacking computer 36 is somewhere on the sub net 22. The sending broker 24 instructs the sending interface device 20 to block at least a portion of the SYN messages passing through it destined for the server under attack (step 520). (The portion that is blocked may be specified by a network administrator at the time of configuring the interface devices via the broker.) This in turn reduces the amount of attacking SYN requests that are received by the server 38, reducing the harm the attack causes the server 38. Alternately, the interface device 20 can be instructed to block a portion of all SYN requests passing through it or a portion of all communications passing through it in general. Blocking communications from sub network 22 may result in valid communications being blocked. However, due to reliability features in TCP network communications, computers on sub network 22 sending valid communications will resend any communications that get blocked. Thus the overall amount of invalid SYN requests that reach the server will be reduced, while valid communications will ultimately be received.

In detecting a flood attack, a flood detector may employ one or more of several detection methods. For example, a flood detector can statistically analyze all communications through the interface device and determine that an uncharacteristically large number of SYN requests are passing through the interface device. Alternately, the flood detector may analyze destination information included in the IP headers prepended to each request and determine that an uncharacteristically large number of SYN requests are directed at a particular server. To detect an uncharacteristically large number of SYN requests, the interface device can monitor the traffic through it to determine the normal level of traffic. This can include continuously monitoring the traffic to determine a moving average. The interface device would then detect spike in traffic that is much larger than the average when a SYN flood attack is occurring. Still another example of a flood detection method is comparing or correlating the number of SYN requests with corresponding final ACK messages in order to determine the number of SYN requests that are valid or invalid. A 5-tuple caching technique can be used to handle packets that have already been seen. When the first SYN message comes in, the cache won't have an entry for the 5-tuple of that message (source IP, destination IP, IP protocol, source port, and destination port). When subsequent packets arrive, there will already be cached information.

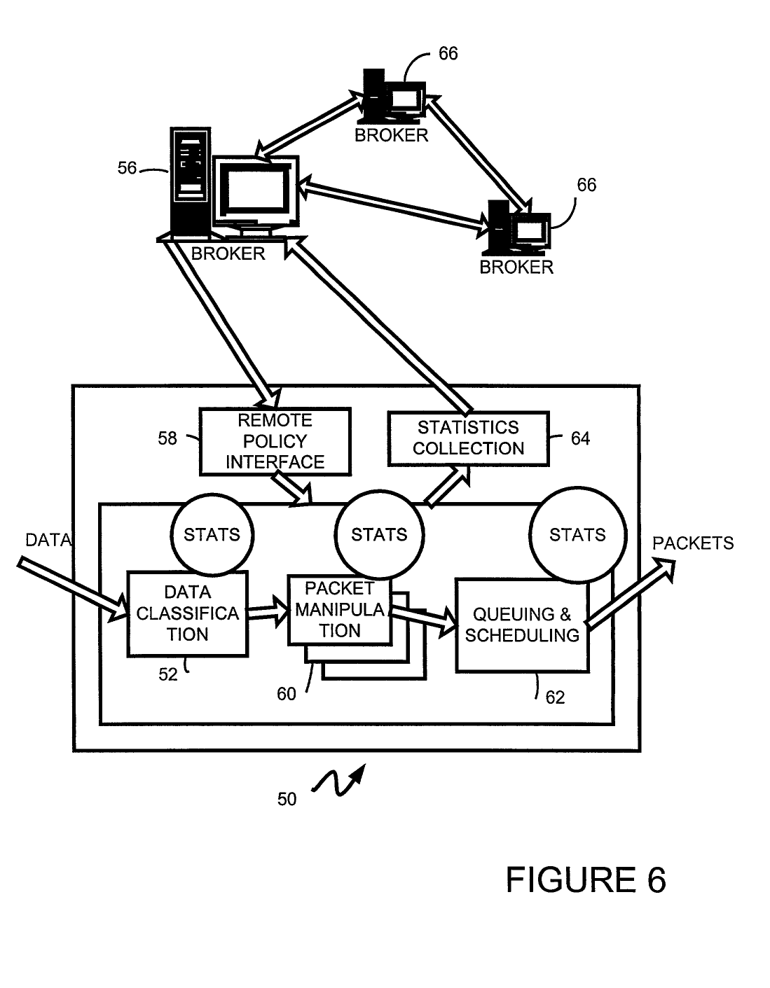

An interface device 50 is shown in FIG. 6. A data message enters the interface device 50 and is classified using a data classification module 52. The data can be classified using a variety of criteria to determine how the network prioritizes and processes the data. The data can include packets of data received from another interface device. The specifics of the data classification conform to a policy. The policy is dictated by a broker 56 corresponding to the interface device 50, and is received through a remote policy interface 58. After classification, the data is encapsulated using a packet manipulation module 60. Data encapsulation can include prepending a header instructing devices on the network how to handle the data. The data is then queued and scheduled for sending as a data packet according to a policy, using a queuing and scheduling module 62. This policy is also received from the broker 56 through the remote policy interface 58. Statistics can be collected from multiple modules in the interface device 50. The statistics collection is managed by a statistics collector 64, and is sent to the broker 56. Brokers 66 corresponding to a plurality of interface devices, communicating among themselves, use the statistics to get a network-wide view of network resource utilization. With this information, brokers can formulate the policies that control the interface devices.

Statistics collected from the various modules can be used to identify a flood attack. The statistics can be analyzed by the statistics collector 64, and indicia of a flood attack can be reported to the broker 56. As described above, indicia can include an uncharacteristically large number of SYN requests in general, an uncharacteristically large number of SYN requests directed to a particular destination, for example, or can be determined from the correlation of SYN requests to final ACK acknowledgements. Alternatively, the statistics collector 64 forwards un-analyzed statistics to the broker 56 and the broker 56 then analyzes the statistics for indicia of a flood attack.

After brokers 56, 66 exchange information, if it is determined that the flood attack is originating through a interface device, the interface device's corresponding broker can send a policy to the interface device through the remote policy interface 58. The policy directs the interface device to alter its handling of data to suppress the flood attack. For example, the policy could instruct the interface device to put a filter in the data classification module 52 to identify SYN requests in general or SYN requests directed to a server. The packet manipulation module 60 is then instructed to drop (fail to forward) the identified SYN requests, or at least a percentage of them. The policy includes information on which packets to drop, such as whether a percentage of all SYN requests are dropped, or only a percentage of SYN requests directed to a particular server. The brokers 56, 66 determine the details of the blocking policy. Other suppression methods could be used.

The invention may be embodied in hardware, firmware, or software, or combinations of them. The software may be stored on tangible media such as memory chips, magnetic media, and optical media or may be delivered for execution electronically from a remote location. The execution of software instructions can be performed by processors, computers, portable devices, or other machines that include processing elements that are interconnected with program memories, bus systems, and I/O devices of any kind.

Other embodiments are within the scope of the following claims. For example, elements of implementations that have been described above separately may be combined in various ways to produce other embodiments.

What is claimed is:

1. A method comprising:
generating information, at first and second points of a network, about unwanted communications that are adapted to substantially reduce the ability of a target device to respond to other communications; and
analyzing the information generated at the first and second points to identify which of the points first carried the unwanted communications.

2. The method of claim 1, also including detecting the direction of the unwanted communications.

3. The method of claim 1, also including identifying the target device.

4. The method of claim 1, also including statistically analyzing the communications to determine if an uncharacteristically large number of communications have passed through at least one of the network points.

5. The method of claim 1, also including statistically analyzing the communications to determine when an uncharacteristically large number of communications have been targeted toward the target device.

6. The method of claim 1, also including correlating communications request messages with acknowledgement messages.

7. The method of claim 1, also including communicating information about the unwanted communications to brokers.

8. The method of claim 7, also including communicating information about the unwanted communications among brokers.

9. The method of claim 1, also including blocking a portion of communications passing through the point through which the unwanted communications originated.

10. The method of claim 9, also including blocking a portion of communication request messages passing through the point through which the unwanted communications originated.

11. The method of claim 1, in which the target device comprises a web server.

12. A method comprising:
identifying a source sub-network of unwanted communications that are adapted to substantially reduce the ability of a target device on a network to respond to other communications, the source sub-network connected to the network through an interface device; and
blocking communications passing through the interface device.

13. The method of claim 12, also including blocking a portion of the communications passing through the interface device.

14. The method of claim 13, also including blocking a portion of communication request messages passing through the interface device.

15. The method of claim 12, also including monitoring communications passing through at least a first point and second point on a path from the source sub-network to the target device.

16. The method of claim 15, also including analyzing the communications passing through the first and second points for indicia of unwanted communications.

17. The method of claim 16, also including statistically analyzing the communications passing through the first and second points for an uncharacteristically large number of communications passing through either point.

18. The method of claim 16, also including statistically analyzing the communications passing through the first and second points for an uncharacteristically large number of communication request messages passing through either point.

19. The method of claim 16, also including correlating communication request messages passing though the first and second points with acknowledgement messages.

20. A system comprising:
first and second interface devices for detecting and generating information about unwanted messages directed to a target device; and
a communications analyzer for analyzing the information generated at the first and second interface devices to identify which of the interface devices first carried the unwanted communications.

21. The system of claim 20, in which the communications analyzer also includes:
an interface monitor corresponding to each interface device; and
a communications link between the interface monitors.

22. The system of claim 21, in which the communications analyzer also includes a statistics analyzer corresponding to each interface device for statistically analyzing the messages that pass through each interface device.

23. The system of claim 22, also including an interface coordinator associated with each interface device for instructing the interface devices to block messages.

24. A system comprising:
a communications monitor for detecting and generating information about unwanted messages originating on a first network and directed to a target device on a second network; and
a gating module for blocking messages passing from the first network to the second network.

25. The system of claim 24, in which the communications monitor includes a plurality of interface monitors for monitoring the passage of messages through a plurality of network points.

26. The system of claim 25, in which the communications monitor also includes a localizer to identify the network point that first carried the unwanted messages.

27. The system of claim 26, in which the communications monitor also includes a statistics analyzer for statistically analyzing the messages passing through the plurality of points.

28. The system of claim 24, in which the gating module is operable to block a portion of the messages passing from the first network to the second network.

29. The system of claim 28, in which the gating module is operable to block a percentage of all messages passing from the first network to the second network.

30. The system of claim 28, in which the gating module is operable to block a portion of communication request messages directed to the target device.

31. A computer program embodied in a computer readable medium, the program capable of configuring a computer to:
generate information, at first and second points of a network, about unwanted communications that are adapted to substantially reduce the ability of a target device to respond to other communications; and
analyze the information generated at the first and second points to identify which of the points first carried the unwanted communications.

32. The program of claim 31, also capable of configuring a computer to block a portion of the communications passing through the point that first carried the unwanted communications.

33. A computer program embodied in a carrier wave, the program capable of configuring a computer to:
generate information, at first and second points of a network, about unwanted communications that are adapted to substantially reduce the ability of a target device to respond to other communications; and
analyze the information generated at the first and second points to identify which of the points first carried the unwanted communications.

34. The program of claim 33, also capable of configuring a computer to block a portion of the communications passing through the point that first carried the unwanted communications.
